(19) United States
(12) Patent Application Publication
(10) Pub. No.: US 2017/0341465 A1
(43) Pub. Date: Nov. 30, 2017

(54) MECANUM-WHEELED VEHICLE AND OPERATING METHOD

(71) Applicant: Omniroll AG, Bellach (CH)

(72) Inventors: Pavel Zdrahal, Pfäffikon (CH); Baudouin Uebelhart, Oberdorf (CH)

(21) Appl. No.: 15/536,323

(22) PCT Filed: Nov. 19, 2015
(86) PCT No.: PCT/EP2015/077153

§ 371 Date: Jun. 15, 2017

(30) Foreign Application Priority Data
Dec. 16, 2014 (EP) 14198361.9

(51) Int. Cl. B60B 19/00; B60B 19/12; B66F 9/075

(52) U.S. Cl. CPC B60B 19/003; B66F 9/0755; B60B 19/12; B66F 9/07522

(57) ABSTRACT

A mecanum-wheeled vehicle (1), in particular for transporting a load, comprising a chassis (5) extending along a longitudinal axis (L) and a width axis (B) oriented perpendicular to the same, said chassis comprising at least four mecanum wheel drives (2; 2a to 2d) which can be controlled via control means (13) for carrying out an omnidirectional operation of the mecanum-wheeled vehicle (1), wherein the chassis (5) has a first chassis section (21a) with at least two (2a, 2b) of the mecanum wheel drives (2; 2a, 2b, 2c, 2d) and a second chassis section (21b) with at least two (2c, 2d) of the mecanum wheel drives (2; 2a, 2b, 2c, 2d). According to the invention, the first and the second chassis sections (21a, 21b) are arranged adjacent along a first adjustment axis (E1) and are mechanically connected to one another such that the spacing between same can be varied, and the spacing between the first and second chassis sections (21a, 21b) is adjustable along a first adjustment axis (E1) by controlling at least one of the mecanum wheel drives (2; 2a, 2b, 2c, 2d) of the first chassis section (21a) and/or of the second chassis section (21b) by means of the control means (13).

### BACKGROUND OF THE INVENTION

The invention relates to a mecanum-wheeled vehicle, in particular for transporting a load, comprising a chassis extending along a longitudinal axis and a width axis oriented perpendicular to the same, said chassis comprising at least four mecanum wheel drives (in general: mecanum wheel drive means) which can be controlled via control means for carrying out an omnidirectional operation of the mecanum-wheeled vehicle. Further the invention relates to a method for operating such a vehicle.

Mecanum-wheeled vehicles are well known. In a mecanum wheel, over the circumference of a rim of the wheel, there are attached several rotatably mounted, typically barrel-shaped rollers at an angle to the rotational axis of the rim of mostly 45° in a rotatable manner. Not the rim, but exclusively the above said rollers make contact to the ground or soil, respectively. Therein, the rollers do not have an direct drive, and they may rotate freely about their respective roller rotational axis (which is extending angular relative to the rotational axis of the rim and/or mecanum wheel). In contrast, the entire mecanum wheel may be driven by a drive, typically an electric motor, with an adjustable sense of rotation and variable rotational speed. Known mecanum-wheeled vehicles usually comprise four wheels which are arranged in a rectangle-pattern. By an appropriate control of the drives of the mecanum wheels, a total movement direction for the vehicle can be adjusted via individual choice of the rotational directions of the mecanum wheels relative to the ground (road), based on the sum of vectors of the individual mecanum wheels. Thus, any desired directions of the vehicle movement, i.e. an omnidirectional operation can be performed.

WO 2013/041310 A1 describes a mecanum wheel improved relative to hitherto known mecanum wheels, which is characterized in that two rims of the mecanum wheel, each carrying rotatable rollers, are connected with one another via damping means, which allow an attenuated relative motion of the rims to one another, whereby uncontrolled hovering states of previous mecanum-wheeled vehicles are avoided which were caused by the shift of a supporting point migrating along the rollers from one roller to another during rotation of the rim.

Mecanum-wheeled vehicles for an omnidirectional operation, especially using the improved mecanum wheels previously described, have proven themselves effective in practice. Due to the relatively complicated construction of mecanum wheels compared to conventional, evenly rolling wheels, the maximum loading capacity of mecanum wheels is subjected to strict limitations. Therefore, up to now, mecanum-wheeled vehicles have been only partly suitable for carrying of loads (payloads) or propelling especially heavy vehicles.

Independent of the problem of the limited loading capacity of mecanum-wheeled vehicles, there is generally the problem in mecanum-wheeled vehicles, that these vehicles must have dimensions which correspond to a load usually to be accommodated—especially the vehicle width is designed such that tilting moments during transport of a load are minimized and/or that the vehicle dimensions are designed in such a manner that a payload can be accommodated. This, however, entails that the width of the mecanum-wheeled vehicle is oversized for journeys with or without a payload. The above considerations also apply to the length of the mecanum-wheeled vehicle. However, the aforementioned oversize of the dimensions for non-loaded operation causes that the vehicles require large parking areas for periods of non-use. Also, due to the size, certain positions can not be reached.

US 2013/068543 A1 describes a mecanum-wheeled vehicle and two chassis sections, which can be folded relative to one another about a folding axis. US 2003/006693 A1 also describes a mecanum-wheeled vehicle comprising chassis sections disposed hinged/foldable relative to one another.

CN 104 149 857 A discloses a mecanum-wheeled vehicle in which a spacing variability of chassis sections is implemented via spindle drives.

### SUMMARY OF THE INVENTION

Based on the above-mentioned prior art, the object of the invention is therefore to disclose a mecanum-wheeled vehicle, which permits a good maneuverability according to the respective application purpose with and/or without a load. Depending on the application purpose, tilting moments should be minimized during the transport of a load, or the possibility of easily accommodating large payloads should be allowed. In addition, the mecanum-wheeled vehicle should be able to be stored or parked on as small parking areas as possible. Further, the objective is to specify an optimized operating method for such a mecanum-wheeled vehicle.

This objective is achieved by a mecanum-wheeled vehicle having the features disclosed herein, i.e. in case of a generic mecanum-wheeled vehicle, in that the chassis has a first chassis section comprising at least two of the mecanum wheel drives of the mecanum-wheeled vehicle and a second chassis section comprising at least two of the mecanum wheel drives of the mecanum-wheeled vehicle, wherein the first and second chassis sections are arranged adjacent to each other along an adjustment axis, and that the first and second chassis sections are mechanically connected to one another such that the spacing between same can be varied (such that said mechanical connection is or remains present even with the differently adjusted spacings), and that the spacing between the first and second chassis sections is adjustable along the first adjustment axis by controlling at least one mecanum wheel drive of the first chassis section and/or at least one mecanum wheel drive of the second chassis section by means of the control means. In other words, the relative positioning of the chassis sections is actuated by controlling the mecanum wheel drive means via the control means with the aid of the mecanum wheel drive means.

With respect to the operating method, the objective is also solved by the features disclosed herein, i.e. in a generic method by adjusting the spacing between the first and second chassis sections along the first adjustment axis by controlling at least one of the mecanum wheel drives of the first chassis section and/or the second chassis section by means of the control means.

Advantageous further developments of the invention are also disclosed herein. All combinations of at least two of the features disclosed in the description, the claims and/or the figures fall within the scope of the invention.

To avoid repetitions, features disclosed according to the device shall be deemed as disclosed and be able to be claimed according to the method, as well. Likewise, features disclosed according to the method shall be considered as disclosed and be claimable according to the device.

The invention is based on the idea of designing the chassis in multiple parts in such a way that the chassis has at least two chassis sections each carrying two mecanum wheel drives, and of mechanically connecting these chassis sections (indirectly or directly) to one another such that the spacing between same can be varied, i.e. in such a way that the distance between the chassis sections along an adjustment axis is preserved while maintaining the mechanical connection, for example by implementing a telescopic or rail connection despite of a distance variation. According to the invention, it is further provided that the adjustment of the spacing between the aforementioned chassis sections, which are arranged adjacent along the (first) mecanum axis, along the (first) adjustment axis by means of a corresponding control of the mecanum drives of the chassis sections is effected by such means that a force is generated, which shifts the chassis sections towards one another, or asunder of one another. For the preferred case that the aforementioned adjustment axis runs in the direction of width extension and thus preferably in parallel to the rotational axes of the mecanum wheels of the mecanum drives, it is possible to increase the spacing between the chassis sections and thus to widen the chassis as a whole by means of a counterrotating rotation of the mecanum wheels of one of the vehicle sections and a simultaneous braking or holding or slower twisting of the mecanum wheels, in particular by a corresponding control of the associated drives, of the opposing chassis section. For narrowing, i.e. for reducing the spacing of the chassis sections, the mecanum wheels of the mecanum wheel drives of one of the chassis sections, again, can be rotated in counterrotating directions, but then each in an opposite direction of rotation, while the mecanum wheels of the opposing chassis section are preferably (but not necessarily) locked or braked, respectively, by an appropriate control.

If, as an alternative, the vehicle length is to be varied, for example, i.e. if the aforesaid adjustment axis extends in the direction of the longitudinal axis of the vehicle, and thus preferably perpendicular to the rotational axes of the mecanum wheels of the mecanum wheel drives, the aforementioned chassis sections are arranged adjacent to each other in the longitudinal direction of the vehicle. In order to extend the vehicle, i.e. for further spacing of the chassis sections from one another, for example, the mecanum wheels arranged on one chassis section can be rotated into a common twisting direction, while the mecanum wheels or mecanum wheel drives, respectively, of the adjacent chassis section are rotated more slowly or are braked or locked, respectively. Moreover, it is possible to rotate the latter mecanum wheel drives in countersense relative to the other mecanum wheel drives. Irrespective of the specific control of the mecanum wheel drives, this must in any case be performed in such a way that a force vector results which moves the chassis sections relative to one another in the desired direction along the adjustment axis.

Very particularly preferred is an embodiment to be explained later, in which both the width and the length of the chassis are varied by means of appropriate control of mecanum wheel drives, wherein the forces required for this are generated at least partially, preferably completely, by appropriate control of the mecanum wheel drives, which, in contrast to conventional wheels, enable—without performing any mechanical steering—to produce force vectors which are oriented at an angle to the longitudinal extension of the chassis. How these force vectors can be generated by appropriate control is basically well known—according to the invention, the corresponding control results in a defined variation of the spacing of at least two chassis sections each carrying two mecanum wheel drives along an adjustment axis which can be oriented in the direction of the width extension or in the direction of the longitudinal extension of the vehicle; i.e. specifically in parallel to the rotational axes of the mecanum wheels or, alternatively, perpendicular thereto. The aforementioned orientation of the rotational axes of the mecanum wheels and the mecanum wheel rims, respectively, is not mandatory, but is of advantage for a simplified controllability and/or adjustability. For example, in this manner, it is possible to arrange the rotational axis of at least one mecanum wheel of at least one of the mecanum wheel drives both at an angle relative to the longitudinal axis of the vehicle and at an angle relative to the width axis of the vehicle, i.e. at an angle relative to the aforementioned axes deviating from 90° in either case. In this instance, the first adjusting axis extends, both in the case of a width adjustability and of a length adjustability, at an angle to the aforesaid mecanum wheel rotational axis. Nevertheless, a spacing variation of the chassis sections spaced apart in the longitudinal direction or width direction then is possible by a corresponding force vector generation by the mecanum wheel drives, and falls within the scope of the invention.

The mecanum-wheeled designed vehicle according to the concept of the invention as well as the operating method according to the invention offer many advantages over known mecanum-wheeled vehicles and, specifically in respect to a width adjustability of the mecanum-wheeled vehicle, utilize the special properties of mecanum wheel drives which each comprise at least one mecanum wheel and at least one drive motor, in particular an electric drive motor. Thus, it is possible to vary the vehicle width and/or vehicle length, in particular solely by means of a corresponding control of the mecanum wheels or mecanum wheel drives, respectively, whereby the mecanum wheeled vehicle, on the one hand for non-load operation, and in particular for parking on a parking lot, is capable to occupy a minimum of floor area. In addition, due to the dimensional variability, it is possible to reach locations which otherwise, with a maximum size, were not to be reached. Furthermore, it is possible for the first time to adapt the chassis to the load, in particular the payload size, in order, for example, to be able to travel with differently dimensioned loads, in particular pallets, or even to travel, in a section-wise manner past a payload laterally, to take up the said subsequently, or to unload the said again, by preferably included lifting means yet to be explained hereinbelow. If necessary, it is also possible to adjust the dimension such that tilting moments are minimized.

As explained, the at least two vehicle chassis sections which can be adjusted relative to one another in the adjusting axis, each carry two mecanum wheel drives for generating the force for the relative displacement of these chassis sections. As explained, each mecanum wheel drive comprises, at least one drive motor, in particular an electric motor, and at least one mecanum wheel, which preferably is rotatable exclusively about one rotational axis, in particular the drive rotational axis. In contrast to conventional drive wheels, the latter is preferably not rotatable about an articulation axis oriented perpendicular to the rotational axis. A mecanum wheel, in each case however, is rotatable about a rotational axis, and furthermore carries, preferred barrel-shaped, rollers distributed over the circumference, by means of which the mecanum wheel rolls on a ground, wherein the roller rotational axes of the rollers are arranged at an angle relative to the respective rotational axis of the mecanum wheel or of the rim of the mecanum wheel, respectively. In a manner known per se, the mecanum wheel drives are controllable or controlled individually or in groups for carrying out an omnidirectional operation of the vehicle via control means such that the mecanum wheels or mecanum wheel groups can be rotated at individual speeds or rotational directions, wherein the desired or predetermined (total or resultant) direction of movement, respectively, of the mecanum vehicle (or partial movements and relative movements of chassis sections each carrying two mecanum wheel drives to one another, respectively) results from a sum of individual vectors of the mecanum wheels. In this manner, nevertheless, any desired direction of movement, i. e. an omnidirectional operation, can be carried out in a preferred fashion irrespective of the omission of a mechanical steering, and there is the possibility of rotating or reversing the entire mecanum-wheeled vehicle on the spot, and/or while moving the mecanum-wheeled vehicle in a desired direction of movement.

Preferably, drives in addition to the mecanum wheel drives for the width and/or length adjustment of the chassis are omitted.

With regard to the implementation of the mechanical fixation variable in spacing, there are various possibilities. It is essential that chassis sections are or stay, respectively, mechanically fixed to one another, directly or indirectly, at different spacings along the adjustment axis. For this purpose, in the simplest case, a mechanical telescopic connection can be implemented between the chassis sections which are to be adjusted along the adjustment axis. It is also considered to arrange one of the chassis sections or both chassis sections adjustably along a connecting rail, etc. One possibility is also that the two chassis sections (connecting chassis section) are indirectly connected to one another via an additional chassis section, for example each by means of a telescopic extension or a similar mechanical connection, and, for distance variation of the chassis sections relative to one another, the spacing of at least one of the chassis sections to this additional, in particular middle connecting chassis section, can be varied by control of mecanum wheel drives.

As mentioned initially, it is particularly preferred if two chassis sections with two mecanum wheel drives each, i.e. one first chassis section and one second chassis section, can be adjusted by corresponding control of mecanum wheel drives of the mecanum-wheeled vehicle along a first adjustment axis. In this context, the first adjustment axis can extend in the longitudinal direction of the vehicle or in the width direction of the vehicle. Now, particularly preferred is an embodiment in which two chassis sections, namely a third and a fourth chassis section each bearing two mecanum wheel drives of the vehicle, are disposed along a second adjustment axis such that the spacing between same can be varied by appropriate control of mecanum wheel drives, wherein the second adjustment axis then preferably extends perpendicular to the first adjustment axis, i.e. in the longitudinal or width direction of the vehicle. The third and the fourth vehicle section must be (directly or indirectly) mechanically connected with one another within the scope of the spacing variability along the second adjustment axis such that the spacing between the same can be varied. Herein, as well, the above described solutions may be implemented.

Now, very particular preference is given to an embodiment in which the third and fourth chassis sections are each formed by partial chassis sections (subsections) of the first and second chassis sections, i.e. preferably four partial chassis sections are present, which are combinable into a first and a second chassis section for spacing-variation along the first adjustment axis pairwise, and alternatively, or simultaneously, pairwise into the third and fourth chassis sections for spacing-variation along the second adjustment axis. Most preferably, herein, the mecanum wheel drives of the third and fourth chassis section are those of the first and second chassis sections, such that, for example, the third chassis section carries a mecanum wheel drive of the first vehicle section and a mecanum wheel drive of the second chassis section, just the same way as the fourth chassis section does. In such a vehicle, a total of four mecanum wheel drives are sufficient. However, more than four mecanum wheel drives are envisioned for the purpose of achieving greater drive moments, as well, and are preferably arranged distributedly over the chassis sections or chassis subsections, respectively.

A previously described mecanum wheel is maximally flexible and can be adjusted both in length and in width, in particular exclusively by means of appropriate control of the mecanum wheel drives of the mecanum-wheeled vehicle.

In an embodiment comprising at least four chassis subsections, which each bear at least one mecanum wheel drive and which can be combined pairwise to form the first and second chassis sections, and pairwise to form the third and fourth chassis sections, it is possible to connect all the partial chassis sections directly mechanically variable with respect to spacing to one another, or with an additional, in particular middle, connecting chassis section. However, an embodiment is very particularly preferred in which the four partial chassis sections are connected to one another in an U-shaped manner such that spacing between the same can be varied so that, for example, the first and the second chassis section along the first adjustment axis are only connected to one another via the partial chassis sections of the third or, alternatively, the fourth chassis section, wherein these partial chassis sections which are directly connected to one another or indirectly connected to one another via a connecting chassis section, are each connected along the second adjustment axis with one partial chassis section, respectively, of the fourth or alternatively the third chassis section. This, consequently, results in an U-shaped construction.

Particularly expedient is an embodiment of the mecanum-wheeled vehicle in which the same comprises lifting means for changing a height spacing, which is orientated perpendicular to the longitudinal axis and to the width axis, between a resting surface for a load which is preferably formed by a lifting fork, and the mecanum drives. The lifting means are preferably designed such that by using them, a load, for example a pallet, can be lifted.

An embodiment has now been found to be particularly advantageous in which the resting surface of the lifting means, in particular a lifting fork comprising two fork-type prongs, in the manner of a forklift fork, is arranged between the first and second chassis sections, such that by variation of the spacing between first and second chassis sections along the first adjustment axis, an adaptation to a load to be received is possible, in particular in a manner, that the first and second chassis sections travel in parallel to the longitudinal extension of a lifting fork laterally past the payload to be loaded, and, after accommodating the payload by actuation of the lifting means, are retractable again for a certain distance via a corresponding control of the mecanum wheel drives.

In the case of the provision of a connecting chassis section already discussed previously, with which two opposing chassis sections, in particular the first and the second chassis sections, are mechanically connected such that the spacing between them can be varied, it is preferred to arrange and/or secure the lifting means at this connecting section.

In order to achieve an increased load-bearing capacity or possibility of charging the mecanum-wheeled vehicle, it is provided within the scope of the further development of the invention that, in addition to the mecanum wheels, there are support means (not in the form of mecanum wheels), which are fixed at the chassis or are mounted on a support element movably supported or fixedly secured at the chassis, in order to support and prop up, respectively, a weight force portion, in particular a main weight force portion, of one of the chassis of the mecanum-wheeled vehicle and of a possible payload on a soil (road). At the same time, it is provided within the scope of the further development to limit the proportion of the weight force of the chassis and any superstructures and/or a possible payload which is to be supported on the ground via the mecanum wheels, in order to prevent an unacceptable overloading of the mecanum wheels. For this purpose, the mecanum wheels are resiliently fixed against the chassis (in parallel to the direction of weight force of the vehicle and/or a payload) on the chassis or the chassis sections, respectively, by means of energy storage means, which are designed and arranged such that only a partial weight force of a total weight force has to be supported by the mecanum wheels on the ground—For this purpose, the energy storage means must be formed in a vertical direction (i.e. in parallel to the weight force direction) and/or perpendicularly (at least with one spring force component) relative to the planar extension of the chassis and relative to a support face defined by the mecanum wheels, for propping up on the ground, in a resilient manner. Preferably, herein, the energy storage means are designed in a manner that the spring path is limited, such that a residual spring path (in the direction of weight force) remains or is ensured when the support means are resting on the ground. In the event that the support means are also to be springy mounted, which is optionally possible, the spring stiffness of the energy storage means is preferably to be selected to be lower than a spring stiffness of optional support energy storage means preferably disposed between the support means and the chassis, by which, optionally, the support means are resiliently mounted relative to the chassis.

As a result, within the scope of the further development, a mecanum-wheeled vehicle is achieved which enables maintaining of one of its omnidirectional operating mode(s) by a corresponding control of the mecanum wheels or their drives, respectively, and which is simultaneously capable of transporting a comparatively large payload, because, due to a corresponding resilient bearing of the mecanum wheels against a chassis and the additional provision of support means, it is ensured that only a fraction of the weight force of the chassis and/or any payload is supported on the ground via the mecanum wheels, while the other or remaining, respectively, fraction of the weight force, especially the larger weight force component, can be supported on the ground via the support means. For this purpose, then, a support face of the support means and the support face of the mecanum wheels are jointly located on the ground, in particular within a common plane (in the case of an ideal planar ground).

In doing so, the spring force or the spring stiffness of the energy storage means is matched to the weight of the chassis, any superstructures and/or a possible payload in such a way that despite a limitation of the weight force component to be supported by the mecanum wheels, a still sufficient weight force component is supported or supportable via the mecanum wheels on the ground, in order to ensure a (sufficient) traction of the mecanum wheels on the ground to ensure propulsion for an omnidirectional movement of the mecanum-wheeled vehicle. In particular, it should be ensured that the traction is sufficient to allow a so-called scribing momentum, which is necessary for overcoming a roll-off resistance of the vehicle, to be transmitted onto the ground or to be jacked at the same, respectively.

In this case, the mecanum wheel drives, the chassis and the support means form an inseparable unit which is capable to be moved collectively, preferably for the case of not-charging a payload such that the support means, as will be explained later in the context of an advantageous further embodiment, will not rest on the ground. In addition to a principal suitability of the mecanum-wheeled vehicle according to the further embodiment for carrying payloads, by virtue of the invention, it is also possible for the first time to construct comparatively heavy mecanum-wheeled vehicles which, for example, comprise heavy, permanent superstructures, and to support the weight force of these superstructures only partially via the mecanum wheels and, for the other part, via the support means on the ground. A vehicle type capable to be produced within the scope of the invention is very particularly preferred in which lifting means are fixed on the chassis by which a payload can be adjusted relative to the chassis in a height-adjustable manner. Such an embodiment makes it possible to drive into underneath a payload and to adjust the payload in height relative to the chassis using the lifting means, such that a portion of the payload weight force is supported on the ground via the support means and only a portion of the weight force is supported via the mecanum wheels. Therein, this weight force component is selected to be sufficiently large to ensure traction of the mecanum wheels on the ground.

There are different possibilities with regard to the specific design of the support means. In the simplest case, it is possible to move the support means haulingly over the ground by driving the mecanum wheels. However, it is particularly preferred if, for friction minimization, the support means are designed in such manner as to move along together with the chassis in a rolling fashion over the ground, by driving the mecanum wheels. Herein, it is most particularly preferred if the support means have a load wheel which is rotatable about a rotational axis running preferably in parallel to the ground, preferably about 360°, in particular in the form of a load roller which during a directional shift of the vehicle by a corresponding control of the mecanum wheel drives is rotatable relative to the chassis about a steering axis extending preferably perpendicular to the rotational axis of the load wheel. For an improved load distribution, it is particularly expedient to provide a plurality of load wheels which are designed in such a way and arranged in an articulated manner. Most preferably, four load wheels are provided which delimit the corners of a rectangle. The at least one load wheel, herein, is preferably designed as a “conventional wheel without additional rollers, which are rotatable relative to the wheel”, i.e. is not designed as a mecanum wheel, and preferably is not driven actively but only indirectly via the mecanum wheels. In addition, the at least one load wheel preferably is not actively rotatable about the articulation axis by means of a steering drive, but only passively by means of a corresponding change of direction of the vehicle. In this regard, an embodiment having an active, i.e. actuated, steering can be implemented, as well, which rotates the load wheel directly driven about an articulated axis, depending on the direction of the vehicle. Additionally, or alternatively to a load wheel rotatable about a rotational axis and about an articulated axis, it is also conceivable to provide support means in form of a rotatably arranged roller, especially arranged within a cage, which can roll omnidirectionally and thus can follow a vehicle direction predetermined by the mecanum wheel drives. In principle, it is also conceivable to provide support means in the form of a rotatable chain, in the manner of a tracked vehicle, in which case it is preferred to provide an active steering system for pivoting such a chain drive (herein, a chain can also be made of a rubber-elastic material) so to adjust a preferential orientation of the chain drive depending on the respective direction of travel of the mecanum wheel. Irrespective of the specific design of the support means, however, the said may preferably be not actively driven but only be indirectly driven by the mecanum wheel drives.

In particular, in the case of a vehicle which is designed to carry or transport a payload, it has been found to be advantageous, to design or set off the energy storage means for the mecanum wheels in such a manner that the support means, in case of a chassis which is not charged with a load and which, optionally, is still carrying superstructures, are arranged above a support face defined by the mecanum wheels, i.e. above the ground, and are lowering themselves together with the chassis, not until they are charged with a dimensioned or heavy load, respectively, with a simultaneous or automatic increase of the spring tension of the energy storage means. In other words, an embodiment is particularly advantageous in which the support means do not contact the ground during an idling run of the mecanum-wheeled vehicle, but only when a corresponding load is applied, which at the same time enables that the means by which the mecanum wheels are borne in spring-loaded fashion relative to the chassis, are strained, wherein, as already explained, a residual spring path of the energy storage means in parallel to the weight force direction should be maintained even in the case of support means being located within the support face defined by the mecanum wheels, in particular in order to be able to compensate for unevenness of the ground and to prevent an excessive load from having to be supported by the mecanum wheels. This is important in order to ensure a controlled omnidirectional propulsion of the mecanum-wheeled vehicle, also in case of unevenness of the ground.

It has been found to be of particular advantage if the support means are arranged or fixed in a height-adjustable manner on the chassis in such manner that a spacing between a support face formed by the support means, with which the support means for supporting a partial load, i.e. a portion of the weight force, rest on the ground, and the ground, or the support face defined by the mecanum wheels, respectively, and thus the spacing between the abovementioned support face and the chassis, can be adjusted in order to limit the spring path which the energy storage means can travel when charging the chassis with a load, until the support face of the support means reaches the ground and/or optional support energy storage means get strained, in accordance to the payload weight, to a maximum. By this feature, simultaneously, the maximum weight force to be supported on the ground by the mecanum wheels is adjusted. As will be explained below, this adjustment of spacing preferably is carried out in accordance to a measured weight force of the payload.

As already indicated initially, an embodiment can be implemented in which exclusively the mecanum wheels are mounted in a springy and/or resilient manner, respectively, against the chassis with the aid of the energy storage means for limiting the load to be carried or supported, and the support means are not. Alternatively, it is conceivable not only to mount the mecanum wheels resiliently against the chassis, but also, in addition, the support means via support energy storage means, wherein the spring stiffness of the support energy storage means is preferably greater than that of the energy storage means, in order to ensure that only a portion of the weight force is supported or can be supported on the ground via the mecanum wheels.

It is particularly expedient for the energy storage means to be designed in such a way that, even in the case of a mecanum-wheeled vehicle which is loaded with a payload, a residual spring path of the energy storage means in parallel to the direction of the weight force remains to ensure a residual spring capacity. In other words, it is preferred if the spring path which can theoretically be maximally travelled until reaching a stop, is parallel to the direction of the weight force, i. e. the corresponding spring path component is longer than the spacing of the support face of the support means to the ground or to the support face defined by the mecanum wheels in an unloaded state, respectively, and/or is longer than a maximum spring path of optional support energy storage means in parallel to the aforesaid weight force direction.

In order to ensure sufficient traction of the mecanum wheel drives and the mecanum wheels, respectively, on the ground under different payloads, it has been found to be advantageous if means for the adjustment of pre-tensioning the energy storage means and/or of a maximum spring path which the energy storage means can travel while increasing the spring tension, until the support means are touching the ground or reach the support face defined by the mecanum wheels, and/or until optional support energy storage means are maximally tensioned according to the payload, can be adjusted, just as well as the weight portion to be maximally supported by the mecanum wheels on the ground. Herein, the said can be means for adjusting the pre-tensioning and/or the spring path which can be driven manually or preferably with the aid of actuator means, in particular an electromotive drive. The aforementioned spring path of the energy storage means can, for example, be adjusted by a variation of spacing between a support face of the support means to the ground or to the chassis, respectively, using a corresponding height-adjustable arrangement of the support means relative to the chassis. In the event of a springy-resilient bearing of the support means against the chassis by corresponding support energy storage means, additionally or alternatively to the aforementioned means for adjusting the pre-tensioning of the energy storage means, (manual or actuated) means for adjusting the pre-tensioning of the support means on the vehicle may be provided.

It is particularly expedient, as mentioned above, when the pre-tensioning of the energy storage means or optional support means, and/or a (maximum) spring path of the energy storage means (in particular the spacing of a support face of support means to a mecanum-wheel support face or to the ground, respectively) can be adjusted as a function of the weight force of a payload, wherein it is particularly preferred if the setting can be done automatically, i.e. using actuator means. It has now been found to be particularly of advantage if the corresponding weight force can be determined with the aid of measuring devices of the mecanum-wheeled vehicle. Herein, this is to say, that the mecanum-wheeled vehicle includes weight force measuring devices which are designed and arranged in such a way that the weight force of a payload or a weight force portion of this payload, which can be supported via the support means or via at least one mecanum wheel on the soil, can be measured, said measuring devices (force measuring devices) being connected in a signal-transmitting manner with corresponding control devices for the control of the aforesaid actuator means, wherein the control devices comprise the actuator means for varying and/or adjusting the pre-tensioning of the energy storage means, and/or the aforementioned spring path and/or a pre-tensioning of any optional support energy storage means, depending on a sensor signal of the measuring devices, i.e. depending on the payload weight (or weight fraction), in order, on the one hand, to limit the stress on the mecanum wheels and, on the other hand, to ensure sufficient traction, in particular to overcome the roll-off inertia of the mecanum-wheeled vehicle.

For the preferred case of the formation of the mecanum-wheeled vehicle as a load vehicle, which is suitable and intended for receiving or transporting a payload, it has been found to be advantageous if a loading device, preferably one of a tipping type, preferably a loading trough, for receiving the payload is mounted on the chassis.

In addition, or alternatively, a lifting means (means for varying the spacing) can be provided on the chassis for relative height adjustment (spacing adjustment) of a payload relative to the chassis, wherein in a preferred embodiment of the mecanum-wheeled vehicle having support means which, without being charged with a payload, are lifted and/or spaced, respectively, from the ground, the lifting means move the chassis in direction of the ground and thereby tension the energy storage means of the mecanum wheels until the support means touch on the ground and/or optional support energy storage means are tensioned. In other words, the lifting means are designed for the relative displacement of a lifting- or resting- or transport-surface relative to the chassis. Preferably, the lifting means comprise a fork, in particular a lifting fork of the type of a forklift truck, or a lifting platform, wherein the lifting fork or lifting platform then form or define the aforementioned resting- or transport-surface of the lifting means for receiving the payload. Preferably, the resting- or transport-surface is aligned or arranged, respectively, in parallel to the support face defined by the mecanum wheels for charging a payload.

There are different possibilities with regard to the specific configuration of the energy storage means for resiliently bearing the mecanum wheels, in particular together with the respective drive (particularly one electric motor in each case). In the simplest case, the energy storage means (spring means) are designed as classical springs, for example as compression springs, such as coil springs and/or torsion springs; the energy storage means may also have combinations of differently shaped springs. Preferably, such springs are formed from metal and/or have a resilient design because of their geometry. It is likewise conceivable for the energy storage means to comprise gas pressure springs or hydraulic springs or a combination of mechanical springs, gas pressure springs and/or hydraulic springs. It is also conceivable to provide spring-loaded or energy-storing energy storage means exclusively or additionally by virtue of the material selection (for example elastomeric material). It is essential that the energy storage means are designed and arranged in such manner that these allow for a limitation of the weight force to be supported by the mecanum wheels during the support means are resting on the ground, i.e. serve for force buffering.

It is very particularly preferred if the mecanum wheels, in particular together with their drives, i.e. the mecanum wheel drives are, via spring-mounted support arms, arranged on the chassis or mounted springy-resilient against the chassis, wherein the support arms are pivotally fixed to the chassis in such a way that the spring tension of the energy storage means changes by pivoting the support arms. An embodiment is particularly preferred in which the pivot angle for adjusting the pre-tensioning of the energy storage means can be varied manually or with the aid of actuator means in order to vary the weight force or weight force component to be supported by the mecanum wheels. Here, it has proved to be particularly advantageous if the energy storage means comprise torsion springs which can be tensioned by pivoting the support arms.

In order to ensure optimum ground contact and to avoid the hovering states known from the prior art, it has been found to be advantageous if the mecanum wheels, as known from WO 2013/041310, comprise two rims which each carry rotatably arranged rollers all over their circumference, wherein the rims are connected to one another via damping means which allow a limited relative movement of the rims, in particular a relative movement in the circumferential direction and/or perpendicular to a mecanum wheel rotational axis and/or perpendicular to a rim-rotational-axis of the rims and/or tilt-angularly to one another. Preferably, the mecanum wheels are designed as described in the aforementioned international patent application.

According to the invention, the first chassis section and the second chassis section are adjustable along the first adjustment axis, in particular translatively, by controlling the mecanum wheel drive means, wherein, in contrast to the folding solutions known from the prior art, no height change of the mecanum-wheeled vehicle, as measured both perpendicular to the longitudinal axis and perpendicular to the width axis, results from the adjusting movement for adjusting the spacing. If present, in a further development of the invention, a third and a fourth chassis section are adjustable, in particular translatively, by a corresponding control of the mecanum wheel drives along the second adjustment axis, wherein, as well, preferably no height change of the mecanum-wheeled vehicle, as measured perpendicular to the longitudinal axis and perpendicular to the width axis, results from such an adjusting movement for varying the spacing.

The invention also relates to a system comprising a mecanum-wheeled vehicle as described above and a (re-detachable or removable) payload carried by it, wherein a weight force of the payload is proportionally supported on a ground via the mecanum wheels and proportionally via the support means. In addition, the invention also results in a method for operating a mecanum-wheeled vehicle designed according to the concept of the invention. The key of the method is that there is supported on the ground a part of the weight force of the chassis and/or a payload [via] of the mecanum wheels, and the other part of the weight force via the supporting means. It is preferred in this context if the weight force which is supported via the mecanum wheels is adjusted as a function of a measured weight force of the payload—in particular, by a corresponding adaptation of the pre-tensioning of the energy storage means and/or of a spring path of the energy storage means, in particular of a maximum spring path of the energy storage means, which must be travelled by the said until the support means touch the ground and/or until optional support energy storage means reach the spring tension maximally caused by the payload.

### BRIEF DESCRIPTION OF THE DRAWINGS

Further advantages, features and details of the invention can be learned from the following description of preferred exemplary embodiments as well as from the drawings.

The said drawings depict, in

FIG. 1a-1d: a mecanum-wheeled vehicle constructed in accordance to the concept of the invention, viewed from below, in different operating states, or having different spacings from chassis sections arranged adjacent to one another, respectively,

FIG. 2: in a schematic view, a mecanum-wheeled vehicle constructed according to the concept of the invention, in a plan view, during different operating states,

FIGS. 3 and 4: an alternative embodiment of a mecanum-wheeled vehicle constructed according to the concept of the invention having lifting means comprising a lifting fork extending perpendicularly to a first adjusting axis, and arranged in a region between a first and a second vehicle section, which are variable in spacing along the adjustment axis,

FIG. 5: a further alternative embodiment of a mecanum-wheeled vehicle formed according to the concept of the invention comprising lifting means,

FIG. 6a: a possible embodiment of a mecanum-wheeled vehicle formed according to the concept of the invention in a side view without payload,

FIG. 6b: a mecanum-wheeled vehicle according to FIG. 6a including a payload,

FIG. 7: a possible embodiment of a mecanum-wheeled vehicle constructed according to the concept of the invention, in the view from below,

FIG. 8: a side view of an alternative embodiment of a mecanum-wheeled vehicle constructed according to the concept of the invention,

FIG. 9: a further alternative embodiment of a mecanum-wheeled vehicle constructed according to the concept of the invention, having integral lifting means, and

FIG. 10: a side view of another alternative embodiment of a mecanum-wheeled vehicle constructed according to the concept of the invention.

In the figures, like elements and elements having the same function are identified by the same reference symbols.

### DETAILED DESCRIPTION

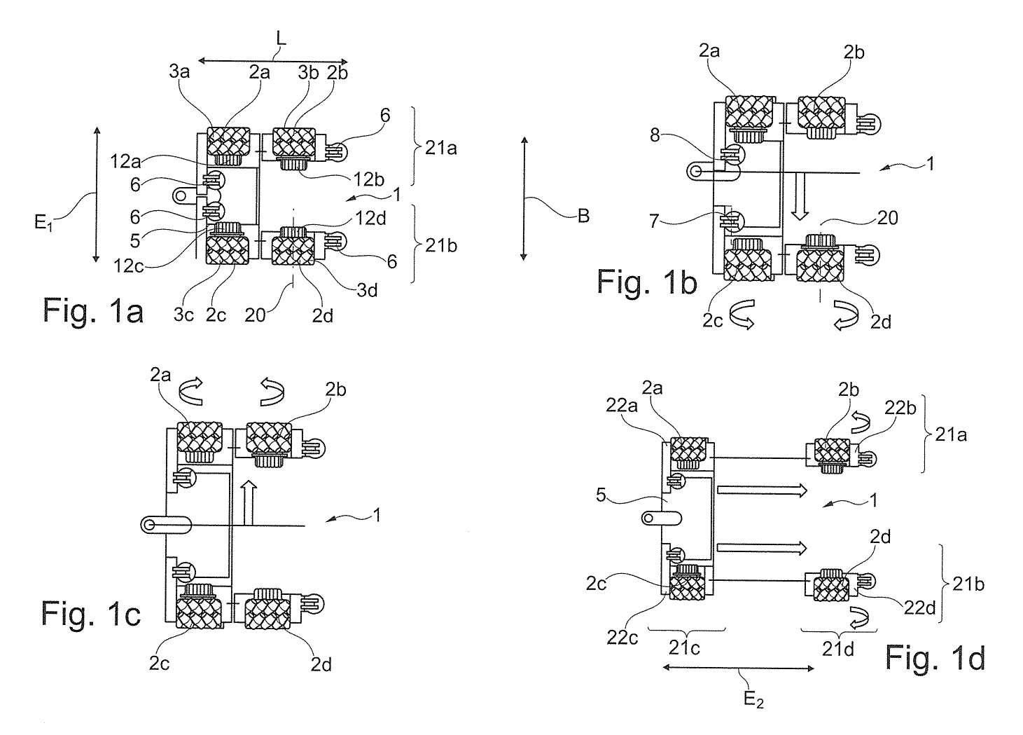

A mecanum-wheeled vehicle 1 is shown in FIGS. 1a to 1d. The same comprises a total of four mecanum wheel drives 2a to 2d, which delimit the corners of an imaginary rectangle. Each mecanum wheel drive 2a to 2d comprises a mecanum wheel 3a to 3d each having an electromotive drive 12a to 12d. All of the mecanum wheel drives 2a to 2d, more specifically the electromotive drives 12a to 12d thereof, are connected to control means (not shown) for individually driving the mecanum wheels 3a to 3d to ensure an omnidirectional operation.

The mecanum wheel drives 2a to 2d are connected to a chassis 5 in a fixed manner, in particular by means of energy storage means to be explained later. In addition to the mecanum wheel drives 2a to 2d, the chassis 5 carries support means 6 which are firmly connected with these, here in the form of load wheels which are rotatably mounted about a respective rotational axis 7 as well as an articulated axis 8 oriented perpendicular thereto. The support means 6 can neither be driven directly about the rotary axis 7 nor about the articulation axis 8 by a separate drive, but by rotating or pivoting about them as a function of a locomotion of the mecanum-wheeled vehicle 1 due to the drive of the mecanum wheels 3a to 3b.

The mecanum-wheeled vehicle 1 or the chassis 5, respectively, comprises a longitudinal axis L as well as a width axis B oriented perpendicularly thereto, the longitudinal axis L being oriented perpendicularly to mecanum wheel rotational axes 20 around which the rims of the mecanum wheels are rotatable. In an angle to these mecanum wheel rotational axes 20 and/or rim rotational axes, there are oriented roller rotational axles about which rollers can roll off, which are held by the mecanum wheel rims at the outer circumference in a manner known per se.

The chassis 5 has a first chassis section 21a including the mecanum wheel drives 2a and 2b and a second chassis section 21b including the mecanum wheel drives 2b and 2c. These two chassis sections 21a and 21b are variable in spacing along a first adjustment axis E1, which herein extends, for example, along the width extension or in parallel to the width axis B. For this purpose, the first and second chassis sections 21a, 21b are connected to one another mechanically, and in a manner variable in spacing, along the adjustment axis E1, for example by a non-shown telescopic or rail connection which is arranged on the left and extends from the top downwards in the drawing plane.

In order to vary the mecanum-wheeled vehicle width, i.e. the extension of the chassis 5 along the width axis B, the mecanum wheel drives 2c and 2d, as shown in FIG. 1b, can, for example, be rotated in opposite senses. Preferably, the mecanum wheel drives 2a and 2b are simultaneously braked or held tight. In any event, the mecanum wheel drives 2a to 2d are controlled in such a way that a force component acts on the chassis sections 21a and 21b along the first adjustment axis E1 such that the chassis sections 21a and 21b move relative to one another along the first adjustment axis E1. As shown in FIG. 1c, simultaneously or timely delayed, the mecanum wheel drives 2a to 2b can be rotated in opposite senses for a further widening, while the mecanum wheel drives 2d are, for example, braked. The adjusting movements resulting from FIGS. 1b and 1c can, in principle, also be carried out simultaneously. In any case, it is essential that the first and second chassis sections 21a and 21b are adjusted relative to each other along the adjustment axis E1 by a corresponding control of the mecanum wheel drives 2a to 2d, while maintaining a mechanical connection variable in spacing.

In particular from FIG. 1d, it can be seen that the chassis 5, in addition to the first and second chassis sections 21a and 21b, includes a third chassis section 21c and a fourth chassis section 21d. The third chassis section 21c comprises the mecanum wheel drive 2a and the mecanum wheel drive 2c, while the fourth chassis section 21d comprises the mecanum wheel drives 2b and 2d. The spacing inbetween the chassis sections 21c and 21d can be varied by a corresponding control of the mecanum wheel drives 2a to 2d, for example by braking or holding the mecanum wheel drives 2a and 2c locked, and simultaneously rotating the mecanum wheel drives 2b and 2d in a common rotational direction, along the second adjustment axis E2 which is running perpendicular to the first adjustment axis E1, while maintaining the distance-variable mechanical connection of the third and fourth chassis sections 21c and 21d along the adjustment axis E2.

An embodiment in which the vehicle can only be adjusted along one of the adjustment axes E1 or E2 is also basically feasible. In the case of the longitudinal adjustability, then, the adjustment axis designated by E2 is the first adjustment axis E1, and the chassis sections 21c and 21d are the first and second chassis sections 21a and 21b, respectively.

In the specific exemplary embodiment, the chassis sections 21a to 21d each consist of pairwise combinations of partial chassis sections (subsections) 22a to 22d of the chassis 5. Specifically, the first chassis section 21a is formed by the subsections 22a and 22b each carrying one mecanum wheel drive 2a or 2b, while the second chassis section 21b is formed by the subsections 22c and 22d having the mecanum wheel drives 2c and 2d, herein for achieving the width adjustability. For achieving length adjustability, the third chassis section 21c is formed by the subsections 22a and 22c having their mecanum wheel drives 2a and 2c, and the fourth chassis section 21d is formed by the subsections 22b and 22d having their mecanum wheel drives 2b and 2d.

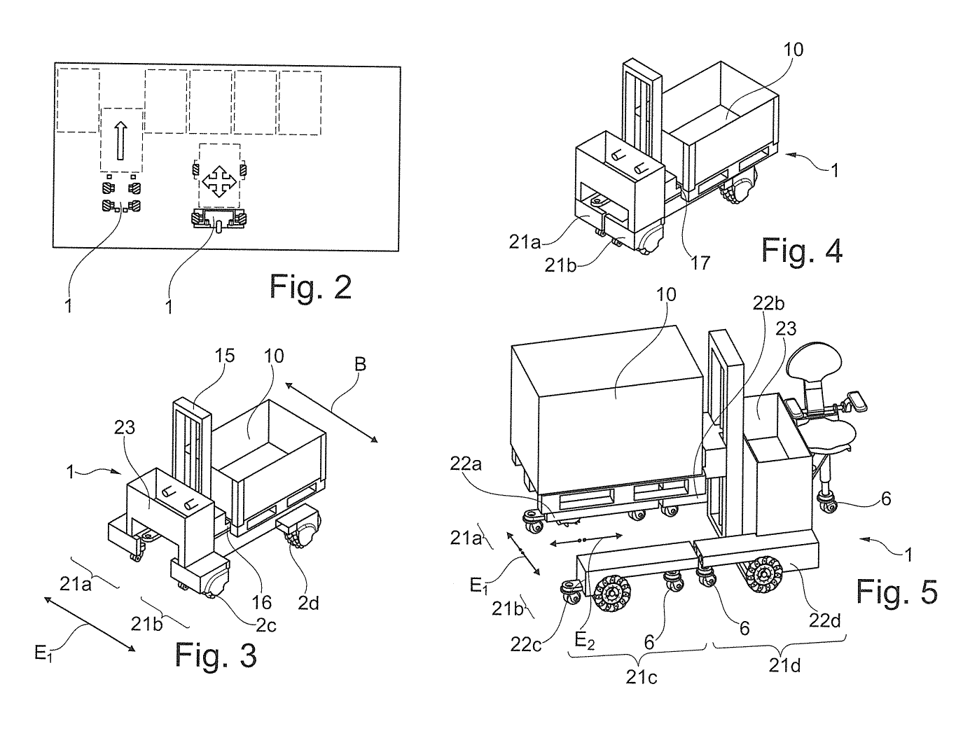

In FIG. 2, a mecanum-wheeled vehicle 1 which in the drawing plane on the left is shown in its minimum area extension, in which the chassis sections 21a to 21d or subsections 22a to 22d are minimally spaced, while in the drawing plane on the right, the chassis is enlarged in width, as well as in length, wherein, as explained repeatedly, basically, also an embodiment can be implemented which is exclusively variable in width or length.

In the FIGS. 3 and 4, a particularly preferred embodiment of a mecanum-wheeled vehicle 1 is shown in the form of a load transport vehicle. Just by way of example, the illustrated mecanum-wheeled vehicle 1 is variable in spacing only along the first adjustment axis E1, wherein the adjustment axis E1, here, again coincides with the width axis B of the vehicle. The mecanum-wheeled vehicle 1 comprises a first chassis section 21a and a second chassis section 21b with their mecanum wheel drives 2a and 2b, or 2c and 2d, respectively, arranged one behind the other, perpendicular to the adjustment axis E1. The two chassis sections 21a and 21b are slidably connected along the adjustment axis E1 to a connecting chassis section 23. In other words, the chassis sections 21a and 21d are slidably connected directly to the said connecting chassis section 23 and, thereby, are indirectly mechanically connected to one another such that the spacing between same can be varied. The spacing between the chassis sections 21a and 21b along the first adjustment axis E1 can be adjusted by a corresponding control of the mecanum wheel drives 2a to 2d, namely between the maximum spacing shown in FIG. 3a and the minimum spacing shown in FIG. 3b. In all relative positions, the mechanical connection of the chassis sections 21a and 21b is maintained.

It can be seen that lifting means 15 comprising a lifting fork 16 are arranged on the connecting chassis section 23. The lifting fork 16 defines or forms a resting surface 17 for a payload 10. The lifting fork 16 is located in a region between the first chassis sections 21a and 21b and extends perpendicular to the first adjustment axis E1.

The above design allows the chassis to be minimized to its minimum width after accommodating the payload 10 (pallet) by corresponding control of the mecanum wheel drives 2a to 2d, whereby the mobility is increased.

If required, the mecanum-wheeled vehicle 1 shown in FIGS. 3 and 4 which is only variable in width, can additionally be designed variable in length, and then a third and a fourth chassis section 21c and 21d are to be provided with two mecanum wheel drives 2c and 2d, each. Therein, preferably, as mecanum wheel drives 2a to 2d the same mecanum wheel drives are used as they are provided for achieving the width adjustability, analogously to the exemplary embodiment according to FIGS. 1a to 1d.

A mecanum-wheeled vehicle 1 is shown in FIG. 5. The design substantially corresponds to the construction of the mecanum-wheeled vehicle 1 according to FIGS. 3 and 4, but, additionally, the mecanum-wheeled vehicle 1 according to FIG. 4 has an extension variability along a second adjustment axis E2. For this purpose, in addition to the first and second chassis sections 21a and 21b, a third and a fourth chassis section 21c and 21d are provided. The two chassis sections 21a and 21b are mechanically connected to one another indirectly via the connecting chassis section 23 such that the spacing between same can be varied. The said is located in a region between the, and optionally above or below the, subsections 22b and 22d. The subsection 22d, otherwise, along the second adjustment axis E2 is only connected with the subsection 22c, as, analogously, the subsection 22b with the subsection 22a. The paired assignment is implemented analogously to the exemplary embodiment according to FIGS. 1a to 1d.

The operation mode of a preferably provided spring-resilient bearing of the mecanum wheel drives 21a to 21d in combination with support means is described below, wherein the further functionality and/or width- and/or longitudinal-variability described above is not detailed—The said is, of course, also in the following embodiment variants, implemented by a multiple-part design of the chassis 5, and a corresponding controller design of the mecanum wheels 3.

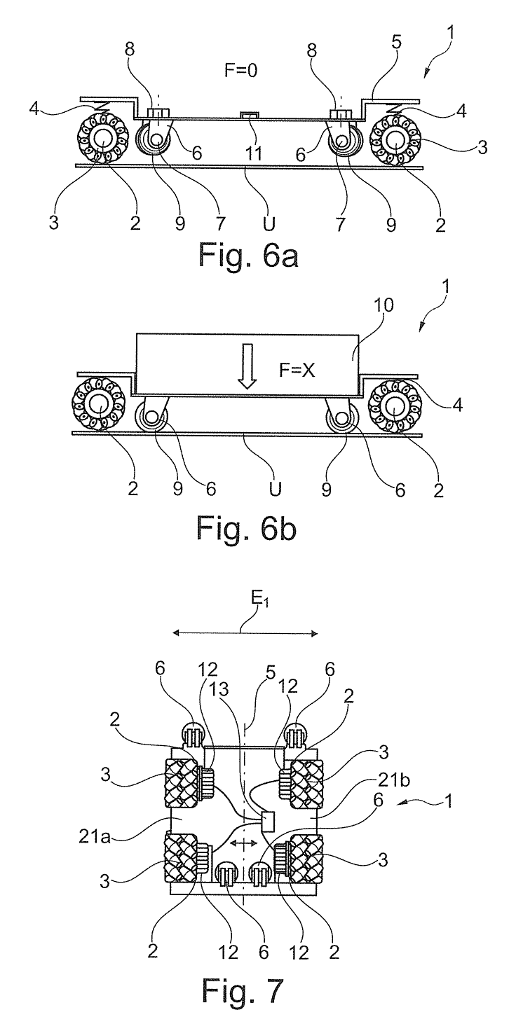

FIGS. 6 and 6b again show the basic principle of a mecanum-wheeled vehicle 1 designed according to the concept of the invention. This comprises a total of four mecanum wheel drives 2 which delimit the corners of an imaginary rectangle and of which only two drives spaced apart in the direction of a longitudinal direction of the vehicle 1 can be seen in the side view. The two other mecanum wheel drives are located behind the said in the drawing plane.

Each mecanum wheel drive 2 comprises a mecanum wheel 3 including an electromotive drive (not shown) arranged thereon. All of the drives are connected in a manner known per se with control means (not shown) for individually driving the mecanum wheels 3 to ensure an omnidirectional operation. The chassis 5 is constructed from several parts for implementing a width- and/or length-variability (not shown; see previous illustrations).

It can be seen that the mecanum wheels 3, together with their drives 2, are spring-resiliently supported via energy storage means 4 against a chassis 5 which carries the mecanum wheels 3 including their drives. The energy storage means 4 are, merely by way of example, illustrated as a coil spring in the context of a simplified illustration. Of course, other springy mountings are also possible. It is essential, that at least one spring-force component oriented perpendicular to a ground U is effective between the chassis 5 and the mecanum wheels 3.

In addition to the mecanum wheels 3, the chassis 5 having a plurality of sections, carries support means 6 which are firmly connected to the said, here in form of load wheels each mounted rotatively about one rotational axis 7, as well as about one articulated axis 8 oriented perpendicular to the said.

The support means 6 may neither be driven about the rotary axis 7 nor about the articulation axis 8 directly by a separate drive, but rotate or pivot about these, respectively, as a function of a locomotion of the mecanum-wheeled vehicle 1 due to the drive of the mecanum wheels 3.

In FIG. 6a, a state without a load is shown. A weight force caused essentially by the chassis 5 in the exemplary embodiment shown, acts via the energy storage means 4 onto the mecanum wheels 3, such that, in the state shown, they are supporting said total weight force on the ground. The support faces 9 (desired contact areas with the ground), which are formed by the support means 6, more precisely by the load wheels, are spaced apart from the ground U.

FIG. 6b shows the mecanum-wheeled vehicle 1 according to FIG. 1a having a payload (load) 10 attached. The said has a weight force F of X Nm. Due to the payload 10 or due to its weight force F, respectively, the energy storage means 4 are tensioned by traveling a spring path in which the chassis 5, with the load 10, automatically shifts downwards in the direction of the weight force against the spring force of the energy storage means 4 until the support means 6 touch on the ground with their support face 9. There remains a small residual spring path of the energy storage means for compensating unevenness of the ground U (residual spring capacity). The weight force to be supported via the mecanum wheels 3 is limited by appropriate selection of the energy storage means 4 and the residual spring path and residual spring capacity, respectively. In other words, only a portion of the weight force of the payload 10 is supported on the ground via the mecanum wheels and the other part is supported on the ground via the support means. The energy storage means 4 are selected in such a way that, with respect to the payload 10 or the corresponding total weight, sufficient traction of the mecanum wheels 3 on the ground U is provided in order to propel the mecanum-wheeled vehicle (omnidirectionally).

Particular preference is given to an embodiment in which the pre-tensioning of the energy storage means 4, in particular as a function of the payload 10 to be loaded, is adjustable and/or a pre-tensioning of optional support energy storage means (not shown herein) is adjustable by which the support means 6 may be springy-resiliently mounted against the chassis 5, if needed. It is also conceivable to adjust the spacing of the support face in relation to the state according to FIG. 1a, without load, for adjusting the spring path and, thus, a residual spring path of the spring, relative to the ground.

At least one of the abovementioned settings is, most preferably, carried out as a function of the weight force to be determined or of a weight force component of the load 10 to be determined. For this purpose, measuring devices (force measuring means) 11 can be provided, for example, on the chassis 5 having a plurality of sections, by which the weight force of a payload can be determined. Depending on this weight force, which can alternatively also be determined outside the mecanum-wheeled vehicle 1, then, one of the above-mentioned settings is carried out manually or via actuator means, wherein it is very particularly preferred if this is performed automatically as a function of a sensor signal of the measuring devices 11 by corresponding controls of the actuator means by control means.

FIG. 7 shows a possible embodiment of a mecanum-wheeled vehicle 1, which is designed according to the concept of the invention, viewed from the bottom. There can be seen the four mecanum wheel drives 2, which delimit the corners of an imaginary rectangle, each comprising one mecanum wheel 3, which can be driven by a drive, here in each case one electromotive drive 12, for ensuring an omnidirectional operation. Therein, the drives 12 are driven by control means 13 in an individual direction and/or at an individual speed.

Each mecanum wheel 3 comprises a plurality of preferably barrel-shaped rollers arranged distributedly over a circumference of the wheel, the roller rotational axles of which are disposed angularly with respect to the mecanum wheel rotational axles, wherein preferably the mecanum wheel rotational axles of two adjacent mecanum wheels are aligned, and the mecanum wheel rotational axes of two mecanum wheel pairs are arranged in parallel to one another.

The chassis 5 comprising a first and a second chassis section 21a and 21b which can be adjusted relative to one another along the first adjustment axis E1 by control of the mecanum wheels 3, can be seen, against which the mecanum wheel drives 2 are mounted resiliently. The chassis 5 also bears support means 6 for carrying a load.

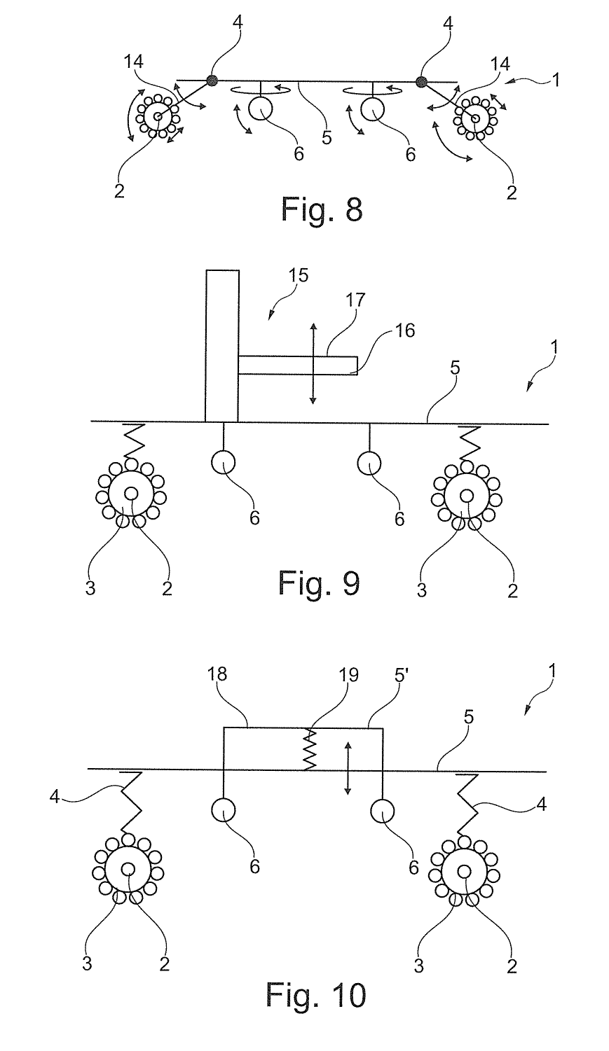

FIG. 8, in a highly schematic form, shows a preferred embodiment of a mecanum-wheeled vehicle 1. The mecanum wheel drives 2 are pivotally mounted on the chassis 5 via support arms 14. Respective energy storage means 4 in the form of torsion springs are assigned to the support arm 14, the torsion springs preferably being pre-tensionable by separate drives (not shown) for varying the pre-tensioning of the energy storage means. Of course, in addition to or as an alternative to torsion springs, differently shaped springs are also usable, e.g. gas pressure springs or coil springs.

Here also, it can be seen that, in addition to the mecanum wheels 3, support means 6 are provided, by which a part of a payload to be carried can be supported on a ground.

FIG. 9 shows, in a highly schematic view, a mecanum-wheeled vehicle 1, which corresponds, in its basic construction, to the exemplary embodiment according to FIGS. 1a to 2. On the chassis 5, there are lifting means 15 (distance varying means) for changing a spacing between a resting surface 17 defined by the lifting means 15 for a load to be transported, and the chassis 5. In the specific embodiment, the lifting means 15 comprise a lifting fork 16 which is arranged so as to be adjustable in height relative to the chassis 5 using, for example, an electromotive drive.

Alternative lifting means 15, for example in the form of platforms which are height-adjustable via a piston-cylinder arrangement, a spindle drive or a scissor-type hinge drive, or the like, can be implemented additionally or alternatively. The drives preferably comprise a motor, in particular an electric motor.

FIG. 10 shows an alternative embodiment of a mecanum-wheeled vehicle 1 including mecanum wheel drives 2 as well as support means 6, which are lifted off from the ground when not being charged with a payload, in analogy to the exemplary embodiment according to FIGS. 1a and 1b. The support means 6 comprise rotatably and steerably arranged rollers, which are fixed to a height-adjustable chassis section of the chassis 5, which in the exemplary embodiment shown, is designated as a support element 18, which, in turn, is fixed in a height-adjustable manner on the chassis 5. In other words, the support means 6 are fixed on the chassis 5 so as to be height-adjustable. The support frame 18 is supported on the chassis 5 via a spring element 19 and serves to receive a payload. Therein, the spring stiffness of the spring element 19 is less than the spring stiffness of the energy storage means 4, whereby the support element 18 lowers itself when the load is applied until the support means 6 or their support face, respectively, reach the ground. In this state, thus, a residual spring path of the energy storage means 4 is ensured, such that only a partial weight force is supported on the ground via the mecanum wheels 3.

1. Mecanum-wheeled vehicle (1) for transporting a load, comprising a chassis (5) extending along a longitudinal axis (L) and a width axis (B) oriented perpendicular to the same, said chassis comprising at least four mecanum wheel drives (2; 2a to 2d) which can be controlled via control means (13) for carrying out an omnidirectional operation of the mecanum-wheeled vehicle (1), wherein the chassis (5) has a first chassis section (21a) with at least two (2a, 2b) of the mecanum wheel drives (2; 2a, 2b, 2c, 2d) and a second chassis section (21b) with at least two (2c, 2d) of the mecanum wheel drives (2; 2a, 2b, 2c, 2d),
wherein
the first and the second chassis sections (21a, 21b) are arranged adjacent along a first adjustment axis (E1) and are mechanically connected to one another such that the spacing between the same can be varied, and the spacing between the first and second chassis sections (21a, 21b) is adjustable along a first adjustment axis (E1) by controlling at least one of the mecanum wheel drives (2; 2a, 2b, 2c, 2d) of the first chassis section (21a) and/or of the second chassis section (21b) by means of the control means (13).

2. Mecanum-wheeled vehicle according to claim 1, wherein the chassis (5) comprises a third chassis section (21c) with at least two (2a, 2b) of the mecanum wheel drives (2; 2a, 2b, 2c, 2d) and a fourth chassis section (21 d) with at least two (2b, 2d) of the mecanum wheel drives (2; 2a, 2b, 2c, 2d), wherein the third and the fourth chassis sections (21c, 21d) are mechanically connected to one another such that the spacing between same can be varied, and wherein the spacing between the third and fourth chassis sections (21c, 21d) is adjustable along a second adjustment axis (E2) extending angularly, especially perpendicular, to the first adjustment axis (E1), by controlling at least one of the mecanum wheel drives (2; 2a, 2b, 2c, 2d) of the third and/or fourth chassis sections (21c, 21 d) by means of the control means (13).

3. Mecanum-wheeled vehicle according to claim 2, wherein the third and the fourth chassis sections (21c, 21 d) each comprise one subsection (22a to 22d) of the first chassis section (21a) which has at least one mecanum wheel drive (2; 2a, 2b, 2c, 2d), and one subsection (22; 22a, 22b, 22c, 22d) of the second chassis section (21b) which has at least one mecanum wheel drive (2; 2a, 2b, 2c, 2d) and is adjacent to the first adjustment axis (E1), or respectively are formed by the said, and that the at least two mecanum wheel drives (2a, 2c) of the third chassis section (21c) comprise at least one mecanum wheel drive (2a) of the first chassis section (21c) and at least one mecanum wheel drive (2c) of the second chassis section (21b) or are formed by the said, and that the at least two mecanum wheel drives (2b, 2d) of the fourth chassis section (21 d) comprise at least one mecanum wheel drive (2b) of the first chassis section (21a) and at least one mecanum wheel drive (2d) of the second chassis section (21b) or are formed by the said.

4. Mecanum-wheeled vehicle according to claim 3, wherein the third and the fourth chassis section (21c, 21d) are directly connected to one another such that the spacing between same can be varied, or using a connecting-chassis-section (23) only via the subsections (22a, 22b) of the first chassis section (21a) or alternatively (22c, 22d) of the second chassis section (21b) or wherein the third and the fourth chassis section (21c, 21 d) are directly connected to one another such that the spacing between same can be varied, or using a connecting-chassis-section (23) both via the subsections (22a, 22b; 22c, 22d) of the first chassis section (21a) and of the second chassis section (21b).

5. Mecanum-wheeled vehicle according to claim 1, wherein the first adjustment axis (E1) coincides with the width axis (B) or the longitudinal axis (L).

6. Mecanum-wheeled vehicle according to claim 1, wherein the mecanum wheel drives (2a to 2d) each comprise at least one, specifically electromotive, drive motor, and at least one mecanum wheel (3), drivable by the said, which is rotatable about a mecanum wheel rotational axis (20) and carries, on the outer circumference, a plurality of rollers which are adjacent in circumferential direction around the mecanum wheel rotational axis (20), wherein the mecanum wheel rotational axes (20) of the mecanum wheels (3) are orientated in parallel to the width axis (B) and perpendicular relative to the longitudinal axis (L).

7. Mecanum-wheeled vehicle according to claim 1, wherein the mecanum-wheeled vehicle (1) comprises lifting means (15) for varying a height-spacing orientated perpendicular relative to the longitudinal axis (L) and to the width axis (B) between a resting surface (17), which is formed by a lifting fork (16) for a payload, and the mecanum wheel drives (2; 2a, 2b, 2c, 2d).

8. Mecanum-wheeled vehicle according to claim 7, wherein the resting surface (17), specifically the lifting fork (16), is arranged between the first and the second chassis section (21a, 21b), and the spacing of the first and/or second chassis sections (21a, 21b) and the resting surface (17) along the first adjustment axis (E1) is adjustable by controlling the mecanum wheel drives (2; 2a, 2b, 2c, 2d) of the first and/or second chassis sections (21a, 21b).

9. Mecanum-wheeled vehicle according to claim 1, wherein a weight force of the chassis (5) is supportable both via the mecanum wheels (3) and, as well, via support means (6) of the mecanum-wheeled vehicle (1) provided in addition to the mecanum wheels (3) on a ground (U), and wherein the mecanum wheel drives (2; 2a, 2b, 2c, 2d) having at least one mecanum wheel (3) each, for limiting the weight force fraction of the chassis (5), and an optional load to be carried by the said, to be supported via the mecanum wheel drives (2; 2a, 2b, 2c, 2d) on the ground (U) are mounted by means of energy storage means (4) resiliently/springy against the chassis (5).

10. Mecanum-wheeled vehicle according to claim 9, wherein the support means (6) comprise at least one load wheel, which during travel of the mecanum-wheeled vehicle (1) is rotatable about a rotational axis (7), and which, during change of direction of the mecanum-wheeled vehicle (1), is rotatable about an articulated axis (8), and/or wherein the support means (6) comprise a ball, which is arranged rotatable, for support on the ground (U).

11. Mecanum-wheeled vehicle according to claim 9, wherein the energy storage means (4) are formed such that the support means (6) are disposed, in the event of the chassis (5) not being charged by a payload, above a support face defined by the mecanum wheels (3), and lower themselves when a load is applied, concomitantly with an increase in the spring tensioning of the energy storage means (4) together with the chassis (5).

12. Mecanum-wheeled vehicle according to claim 11, wherein the spacing between a support face (9) formed be the support means (6) and the support face defined by the mecanum wheels (3) is adjustable.

13. Mecanum-wheeled vehicle according to claim 9, wherein the support means (6) are not springy mounted against the chassis (5) or are springy mounted against the chassis (5) via support energy storage means such that a spring stiffness of the support energy storage means is larger than a spring stiffness of the energy storage means (4).

14. Mecanum-wheeled vehicle according to claim 9, wherein a pre-tensioning of the energy storage means (4) and/or a spring path of the energy storage means (4) for adjusting the weight fraction maximally to be supported by the mecanum wheels (3) on the ground (U) can be adjusted manually or by using actuator means.

15. Mecanum-wheeled vehicle according to claim 9, wherein the mecanum-wheeled vehicle (1) comprises measuring devices for determining a weight force or a weight force fraction of the chassis (5) and/or a payload, and wherein the measuring devices are connected in a signal-transmitting way with control means (13) for controlling the actuator means for adjusting the pre-tensioning of the energy storage means (4) and/or the spring path as a function of a sensor signal of the measuring devices.

16. Mecanum-wheeled vehicle according to claim 1, wherein the first chassis section (21a) and the second chassis section (21b), can be adjusted along the first adjustment axis (E1), without a change of a height of the mecanum-wheeled vehicle (1), as measured perpendicular to the longitudinal axis (L) and to the width axis (B), resulting therefrom.

17. Method for operating a mecanum-wheeled vehicle (1) according to claim 1, wherein the spacing between the first and second chassis sections (21a and 21b) along a first adjustment axis (E1) is adjusted by controlling of at least one of the mecanum wheel drives (2; 2a, 2b, 2c, 2d) of the first chassis section (21a) and/or the second chassis section (21b) by means of the control means (13).
